(19) United States
(12) Patent Application Publication
(10) Pub. No.: US 2012/0023033 A1
(43) Pub. Date: Jan. 26, 2012

(54) TRANSPORT INFORMATION SYSTEM

(75) Inventor: Martin Tomasz, San Francisco, CA (US)

(73) Assignee: Martin Tomasz, San Francisco, CA (US)

(21) Appl. No.: 13/186,586

(22) Filed: Jul. 20, 2011

Related U.S. Application Data
(60) Provisional application No. 61/366,326, filed on Jul. 21, 2010.

(51) Int. Cl. G06Q 10/00

(52) U.S. Cl. 705/345

(57) ABSTRACT

A transport information system provides information and communications to enable the self-directed coordination of multiple vehicles engaged in a transportation service primarily targeted at passengers. The system provides the driver of each vehicle with information comprising a choice of routes or trips requiring service, each with a corresponding fee to be charged to the driver, or an incentive to be paid to the driver. A fee/incentive determiner determines the fees and incentives based on a number of factors, which may include an estimate of fare revenue anticipated for servicing the routes or trips. The transport information system strives to offset differences in fare revenue between the various routes or trips by varying the fees and incentives, thus motivating the drivers to service all the route and trips.

### CROSS-REFERENCE TO RELATED APPLICATIONS

The application claims priority under 35 U.S.C. 119(e) from co-pending U.S Provisional Patent Application No. 61/366,326 entitled “Transport Information System,” filed on Jul. 21, 2010, which is incorporated by reference herein in its entirety.

### BACKGROUND

1. Field of the Invention

The present invention relates to a transport information system for providing information to enable the self-directed coordination of multiple vehicles engaged in the transportation of people or materials.

2. Background of the Invention

In the arena of transportation services, where a multiplicity of vehicles are serving a common geographical region, the efforts of these vehicles must be coordinated in order to provide effective service to customers. Especially in the case where such transportation vehicles serve passengers, the goal of such coordination should be to ensure all regions of the geographical region are served comprehensively, with efficient, customer-focused service.

In most municipal public bus transit services, a fleet of buses are coordinated to operate on fixed routes, servicing multiple stops along the routes according to a fixed schedule within a municipal transit service region. The buses are deployed on routes chosen to best serve the public, as determined by municipal transit planners, and so the region is served comprehensively with predictably scheduled service.

However, the bus operators are typically employees of the municipality or bus operating company, and are not directly incentivized by passenger fares collected. This arrangement does not take advantage of the benefits of drivers motivated to collect fares. For example, municipal public bus services typically operate less efficiently, in part because good utilization of capacity and load balancing between vehicles is not accomplished as easily as it is with fare incentive-driven operators of vehicles which strive to keep their vehicles full and their customers serviced rapidly. Fare incentive-driven drivers tend to offer more efficient, customer-focused service.

On the other hand, certain types of “jitney bus” services also operate fleets of buses on fixed routes, but differ from the municipal public bus service in that the drivers of the buses are motivated by fares. In a typical arrangement, a jitney bus driver is provided a permit to drive a route mutually agreed to by the jitney bus driver (or a jitney operating company) and the municipality. The jitney bus driver subsequently earns the fares collected from passengers by servicing the route. This arrangement does provide the benefits of fare -motivated drivers, maximizing efficient, customer-focused service. However, these fare-motivated jitney bus drivers will tend to operate on routes and operate during hours when the greatest potential concentration of fare paying passengers are found. Thus, jitney bus services often focus on principal routes at peak travel hours, and do not serve regions comprehensively and with a predictable frequency of service.

Other passenger transportation services such as taxicabs or paratransit services focus on point-to-point (trip) service rather than route service, and are typically single-passenger services are offered at a premium cost over fixed-route services. In the case of taxicabs, pedestrians generally request taxi rides either by hailing taxicabs or by contacting a taxi dispatcher. The dispatcher matches customers' specific trip needs with taxicabs to serve them. In this case, the dispatcher coordinates by communications systems such as shown in FIG. 1, providing a choice of trips requested by customers (e.g. phone customer 130) to the fleet of taxicabs, utilizing radio 110 to contact example taxicab 120 via radio 121. Like jitney drivers, taxicab drivers are typically fare-motivated, and thus choose from among the choices of trips offered by the dispatcher based on their estimation of the fares to be collected. While the premium fares generated by a taxicab trip often motivates drivers to service most trips offered by the dispatcher, a problem exists similar to jitney buses in that the drivers will tend to favor accepting trips in limited areas where their passengers are most likely to be, to ensure a rapidly re-occupied taxi after servicing a trip, potentially leaving many areas within the service region underserved.

Thus, there remains a need for a system for coordinating a multiplicity of transportation vehicles which utilize fare incentive-driven drivers to provide efficient, customer-oriented service, while also serving the transit service region comprehensively and with a predictable frequency of service.

### SUMMARY

A transport information system provides information and communications to enable the self-directed coordination of multiple vehicles engaged in a transportation service primarily targeted at passengers. The system provides the driver of each vehicle with information comprising a choice of routes or trips requiring service, each with a corresponding fee to be charged to the driver, or an incentive to be paid to the driver. Considering this information, and further considering the driver's own estimation of any fare revenue which may be collected, the driver may offer to service any of the choices of routes or trips, collecting fares (if any) from servicing the routes or trips, and agreeing to pay the corresponding fee or accepting the corresponding incentive. The transport information system strives to offset differences in fare revenue between the various routes or trips by utilizing these fees and incentives, thus reducing the differences in financial attractiveness of servicing the various routes and trips, and motivating the drivers to service all of the routes and trips. In a typical scenario, if a route or trip is expected to yield low fare revenue, the transit information system communicates a lower fee to be charged to the driver for servicing the trip or route. In some routes or trips when fare revenue is very low or nonexistent, an incentive paid to the driver, rather than a fee charged the driver, may be communicated to motivate drivers to service the route or trip. Conversely, if a route or trip is expected to yield high fare revenue, the transit information system communicates a higher fee to be charged to the driver for servicing the trip or route. Thus, the transport information system enables a self-directed coordination of multiple transport vehicles, by communicating fees and incentives to drivers to motivate them to service of all routes or trips, while maintaining a fare-incentivized transportation service to ensure efficient, customer-focused service.

In one embodiment, the transport information system includes a fee/incentive determiner for determining a fee or incentive for each route or trip. The fee/incentive determiner determines the fee or incentive based on an estimated fare revenue (if any) which may be collected from servicing a given route or trip. The estimated fare revenue may change over time, and thus the fee or incentive offered may be updated more than once per day. In some cases, the route or trip offers little or no fare revenue, in which case an incentive is offered. The transport information system then communicates the fares and incentives to the vehicle drivers.

In another embodiment, the fee/incentive determiner determines a fee or incentive based on a number of factors, including a target driver revenue, urgency and value to the Public as determined by a transit coordinator, service quality, scheduled and unscheduled customer demand, real-time and historical fare revenue generated from the route or trip, real-time and historical load factor and headway information from the vehicles, historical fee and incentive data, estimated fuel costs and dead time, and the level of interest or bids from the drivers. The transport information system further includes a communications subsystem, enabling the drivers to receive the determined fee or incentive information from the fee/incentive determiner, and further enables the drivers to submit a response.

In another embodiment, the fee/incentive determiner determines a fee or incentive for each route or trip based on a bidding scheme, wherein drivers submit bids representing a willingness to service a given route or trip for a driver-proposed fee or incentive. The fee/incentive determiner then accepts or declines the bids, based on factors including the value of the bid. The transport information system further includes a communications subsystem, enabling the fee/incentive determiner to receive bids from the drivers.

In another embodiment, the transport information system includes an in-vehicle data collection and communications system, comprising a location determining device for estimating the real-time location and speed of the vehicle, a load monitoring device for estimating the transport load of the vehicle, such as a fare-collection monitoring device, and a radio system for transmitting this information to the fee/incentive determiner. This information assists the fee/incentive determiner in determining the fee or incentive for each route or trip by including the estimated load, location, and speed of the vehicle in the determination.

In another embodiment, the transport information system includes a system for a customer of the transportation service to communicate to the fee/incentive determiner. The customer may communicate information regarding his or her desire to engage the transportation service, as well as details such as pickup location, drop-off location, desired timing of service, desired mode of transportation, and any other information from the customer that relates to the transportation service. The information communicated by a combination of customers may be used as a factor in determining the load demand for a particular route or trip, and may be used as a factor in determining the fee or incentive for each route or trip.

### BRIEF DESCRIPTION OF THE DRAWINGS

The teachings of the present invention can be readily understood by considering the following detailed description in conjunction with the accompanying drawings.

FIG. 1 describes a prior art system.

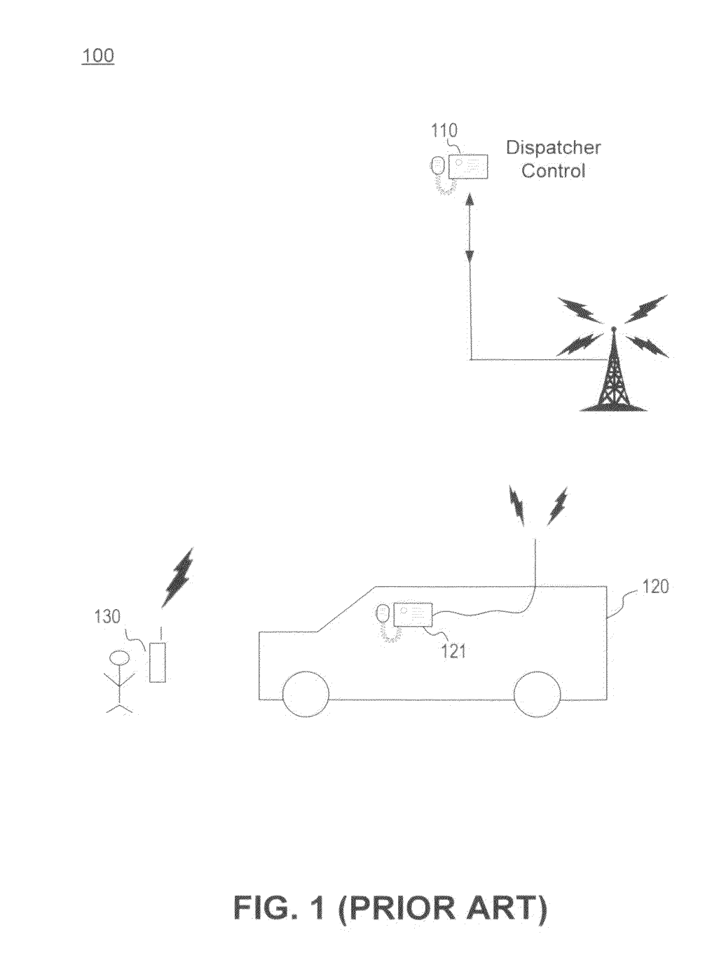

FIG. 2 illustrates several embodiments of the invention.

FIG. 3 shows a map supporting the explanation of various aspects of the invention.

FIG. 4 illustrates several embodiments of the invention.

FIG. 5 illustrates several embodiments of the invention.

FIG. 6 shows a map supporting the explanation of various aspects of the invention.

FIG. 7 illustrates a method to enable the self-directed coordination of multiple vehicles engaged a transportation service, according to the present invention.

### DETAILED DESCRIPTION OF EMBODIMENTS

The Figures (FIG.) and the following description relate to preferred embodiments of the present invention by way of illustration only. It should be noted that from the following discussion, alternative embodiments of the structures and methods disclosed herein will be readily recognized as viable alternatives that may be employed without departing from the principles of the claimed invention.

Reference will now be made to several embodiments of the present invention(s), examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

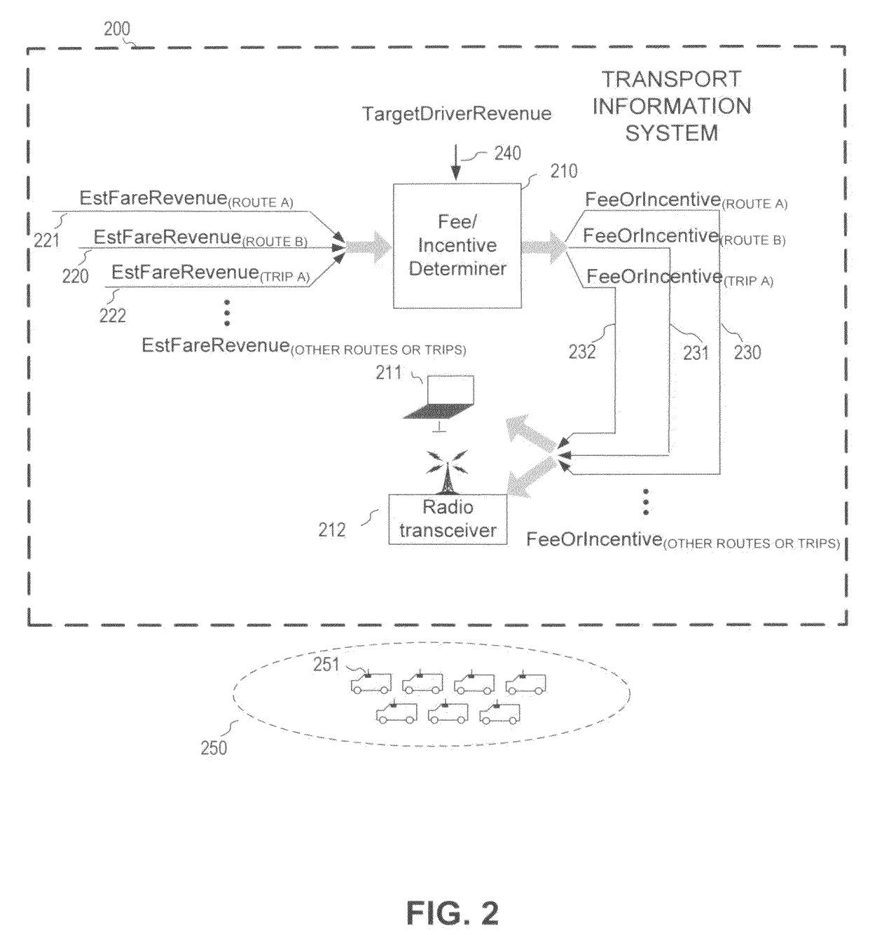

FIG. 2 illustrates an embodiment of the invention. In this embodiment, fleet 250 may comprise a collection of vehicles engaged in the business of transporting people, either stopping to pick up or drop off passengers along various specified routes, or servicing passengers on point-to-point trips, or a combination of such routes and trips. The drivers of the vehicles in fleet 250 may be operating as independent contractors, and may derive their income at least in part from the collection of fares from passengers in exchange for their services.

Transport information system 200 comprises a fee/incentive determiner 210 for determining fees and incentives for various routes and trips to be serviced, and apparatus for communicating such fees and incentives, such as computer display 211 or radio transceiver 212. As will be shown, utilizing these components, transport information system 200 provides information and communications to enable the self-directed coordination of fleet 250.

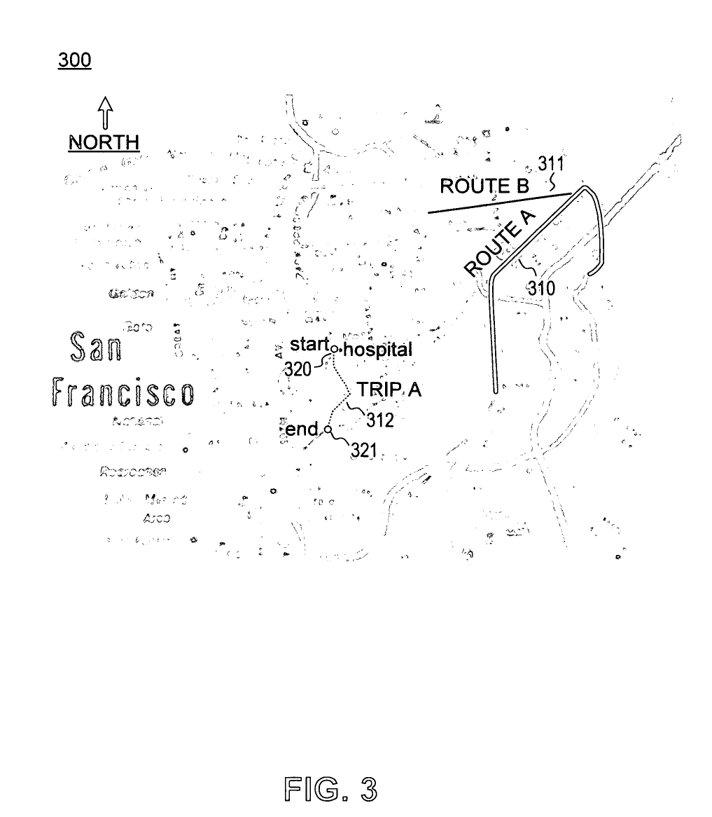

Turning to FIG. 3, map 300 shows an example illustrating ROUTE A (310), ROUTE B (311), and TRIP A (312) in the city of San Francisco, and will be used to illustrate the functioning of the transport information system 200. ROUTE A denotes a multiple-stop, unscheduled passenger transport route, and serves a major business corridor, connecting passengers in the downtown San Francisco financial business district with other business areas to the south. ROUTE B also serves a portion of the San Francisco financial business district, transporting passengers from this area to a more residential zone to the west. For simplicity, it is assumed the fares for any distance of travel within ROUTE A or ROUTE B are equivalent, though this is not necessarily required. Finally, TRIP A denotes a single, point-to-point paratransit trip, in which a disabled passenger is to be transported from hospital 320 to a residence 321 at a certain time on a certain day.

On business days during business hours, ROUTE A serves a much higher density of passengers than ROUTE B. In an unregulated, fare-driven system, where the drivers of vehicles in fleet 250 are free to service any pre-designated route and collect fares from the served passengers, a large number of the vehicles in fleet 250 may be attracted to serve ROUTE A to capture the large potential fare revenue, with fewer vehicles in fleet 250 serving the less attractive ROUTE B. As the number of vehicles serving ROUTE A increases, the fare revenue per vehicle decreases as each vehicle serves fewer passengers. Eventually, a natural equilibrium may be reached, with fare revenues per vehicle for drivers serving ROUTE A equaling those serving ROUTE B, leaving a relatively large number of vehicles serving ROUTE A, and a smaller number serving ROUTE B.

An obvious consequence of this arrangement is that ROUTE B will service passengers at a lower frequency- that is, the headway (time between vehicles) may be increased to a level causing passenger wait times for vehicles to be unacceptably long. In order to remedy this situation, a city permitting agency may provide limited, fixed numbers of permits to serve ROUTE A and ROUTE B, ensuring a sufficient number of permits for ROUTE B to ensure an acceptable frequency of service for ROUTE B. Providing a fixed number of permits for ROUTE A and ROUTE B may not solve the problem satisfactorily, however. Permits for ROUTE B may go unclaimed if the fare revenue per vehicle is too low. Permits for the higher fare revenue ROUTE A may acquire a de-facto value above the permits for ROUTE B, thus creating an undesirable incentive for trade, barter, or monetary exchange for the permits. Also, such fixed permits, if assigned to specific vehicles and drivers, restrict the drivers in their ability to freely service the routes of their choice, diminishing their independence and freedom to operate as fare-seeking independent contractors, thereby potentially diminishing their entrepreneurial motivation and customer-focused service.

The demand for ROUTE A and ROUTE B may be variable depending on time of day. For example, ROUTE B may experience a substantial drop in passengers during the middle of the day, since this route primarily serves passengers travelling between their home and workplace, with most passengers requiring service at the beginning and end of the standard workday. On the other hand, ROUTE A may experience a rise in passengers during the middle of the day, during the lunch hour. Clearly, during these mid-day periods, the vehicles serving ROUTE A are better utilized serving ROUTE B. However, a system with fixed numbers of permits for each route and/or permits assigned to specific vehicles or drivers cannot service such a dynamic service load efficiently.

Finally, it may be desirable to utilize the vehicles in fleet 250 to service TRIP A. However, since trips such as TRIP A may not be scheduled in advance, an adequate servicing of such trips would require reserving a vehicle from fleet 250 in anticipation of servicing trips such as TRIP A. These vehicles would likely be underutilized, resulting in costly and inefficient service.

Returning to FIG. 2, transport information system 200 solves the problems just described in servicing ROUTE A, ROUTE B, and TRIP A, by communicating appropriate financial motivation to enable a self- coordination of the vehicles in fleet 250 to service each route and trip. Specifically, transport information system 200 utilizes fee/incentive determiner 210 to determine a specific fee (to be paid by the driver) or incentive (an amount paid to the driver), appropriate to each route or trip, and communicates this information to the drivers of vehicles in fleet 250. Considering this information, and further considering the drivers' own estimation of any fare revenue which may be collected, the drivers may offer to service any of the routes or trips, collecting fares (if any) from the servicing of the routes or trips, and agreeing to pay the corresponding fee or to receive the corresponding incentive.

In one embodiment, fee/incentive determiner 210 is provided with the estimated fare revenues a driver may expect to collect (if any) while servicing ROUTE A, ROUTE B, and TRIP A, denoted in FIG. 2 as EstFareRevenue (ROUTE A) 220, EstFareRevenue(ROUTE B) 221, and EstFareRevenue(TRIP A) 222. The fare revenue for ROUTE A and ROUTE B may be estimated as the fares collected per hour from a historical record of the fares collected in the past, during which the required number of vehicles are serving ROUTE A and ROUTE B. The fare revenue for TRIP A may be estimated as the fares collected per hour, scaled by the estimated trip time, in hours. Since fare revenues and trip times vary according to the time of day, unique values for EstFareRevenue (ROUTE A) 220, EstFareRevenue(ROUTE B) 221, and EstFareRevenue(TRIP A) 222 may be provided each hour of each day.

Further, fee/incentive determiner 210 may also be provided with a target driver revenue value, TargetDriverRevenue 240. This value represents the target revenue that is determined as appropriate for the drivers. For example, a TargetDriverRevenue 240 value of $20/hr means a typical driver should earn $20 per hour in revenue. Given this information, the following formulas may be applied to determine the fee or incentive value FeeOrIncentive for each trip or route:

FeeOrIncentive (ROUTE A)=TargetDriverRevenue−EstFareRevenue(ROUTE A)

FeeOrIncentive(ROUTE B)=TargetDriverRevenue−EstFareRevenue(ROUTE B)

FeeOrIncentive(TRIP A)=TargetDriverRevenue−EstFareRevenue(TRIP A)

The FeeOrIncentive value represents the fee charged or incentive provided to the driver servicing the given route or trip, per hour of service. Note that in the above formulas, if the estimated fare revenue value EstFareRevenue for a given trip or route exceeds the TargetDriverRevenue, then the FeeOrIncentive value is a positive number. In this case, a fee is charged to the driver in the amount of the FeeOrIncentive value. If the estimated fare revenue value EstFareRevenue for a given trip or route is less than the TargetDriver revenue, an incentive is provided the driver in the amount of the FeeOrIncentive value. In some cases, the fare revenue may be nonexistent—for example, in the case of school trip serving students who do not pay fares. In this case, EstFareRevenue value is zero, and the FeeOrIncentive value equals the TargetDriverRevenue value, so the driver is provided an incentive equal to the TargetDriverRevenue value.

By calculating the FeeOrIncentive value for each route or trip, and holding constant the TargetDriverRevenue value, a theoretically equal financial incentive exists for the drivers to service any of the routes or trips, thus ensuring the routes and trips are serviced comprehensively. Fee/incentive determiner 210 may be realized as a computer program running on a computer, with the input values of TargetDriverRevenue 240, EstFareRevenue (ROUTE A) 220, EstFareRevenue(ROUTE B) 221, EstFareRevenue(TRIP A) 222, as well as the estimated fare revenue from any other routes or trips provided to the program from stored memory such as a hard disk drive. The computer program thus computes the corresponding values for FeeOrIncentive(ROUTE A) 232, FeeOrIncentive (ROUTE B) 231, FeeOrIncentive (TRIP A) 230, and the estimated fee or incentive for any other routes or trips.

While the FeeOrIncentive for each route or trip may be computed in an automated fashion as described, more simple, empirical methods may also be used. For example, the fee or incentive for any route or trip may be determined by a transit planner who has knowledge of the routes and trips to be served, and thus the transit planner may manually choose values for FeeOrIncentive(ROUTE A) 232, FeeOrIncentive (ROUTE B) 231, FeeOrIncentive (TRIP A) 230, and the estimated fee or incentive for any other routes or trips, without considering other inputs such as estimated fare revenues or target driver revenue. Especially in simpler systems, in which few routes and trips are to be coordinated, the past experience of the transit planner may be sufficient to adequately choose these values.

The values for FeeOrIncentive(ROUTE A) 232, FeeOrIncentive (ROUTE B) 231, FeeOrIncentive (TRIP A) 230, and the estimated fee or incentive for any other routes or trips may be communicated to the drivers of the vehicles in fleet 250 utilizing a computer monitor display 211 which may be connected to a local computer, allowing the drivers to enter choices of routes or trips they wish to service, and during what days and times. A given driver will thus make choices to serve routes or trips based on their own estimation of any fare revenue which may be collected, as well as the fees or incentives determined by fee/incentive determiner 210 displayed on computer monitor display 211. The local computer connected to display 211 may register the drivers' choices of routes and trips, and remove from the list of choices any routes or trips that have the required number of vehicles serving them.

Passenger demand on routes may vary during the day. In the example previously given, ROUTE A may experience a surge in passenger demand mid-day, while ROUTE B may experience a drop in passenger demand during the same period. A transit planner may determine that several vehicles from ROUTE B should switch to ROUTE A during this period. Since the number of vehicles that will be operating on ROUTE A and ROUTE B is different during this period, a fee or incentive is determined by fee/incentive determiner 210 by subtracting updated estimates of fare revenue from target driver revenue for this new configuration. Computer monitor display 211 may display additional openings for drivers to service ROUTE A, and reduced openings to service ROUTE B during the hours comprising this mid-day period, along with the corresponding fees or incentives. Since the new fees and incentives determined by fee/incentive determiner 210 for ROUTE A and ROUTE B reflect a theoretically equivalent financial incentive for the drivers to service ROUTE A or ROUTE B, resistance from the drivers to switching routes is minimized.

In one embodiment, FeeOIincentive (ROUTE A) 232, FeeOrIncentive (ROUTE B) 231, and FeeOrIncentive (TRIP A) 230, and the estimated fee or incentive for any other routes or trips may be communicated by radio transceiver 212 to the drivers of fleet 250. Each vehicle in fleet 250 may be equipped with a two-way communications apparatus, such as radio 251. Radio 251 may be a cellular radio, cellular phone, smartphone, or a radio operating on a reserved radio band. With such a system, the vehicle drivers may respond in real-time to service new routes or trips during the day. For example, TRIP A may be unscheduled and require service mid-day. By communicating the information regarding the FeeOrIncentive(TRIP A) 230 in real-time, one of the drivers of vehicles in fleet 250 may decide to change their current servicing of ROUTE B, for example, and choose instead to service TRIP A.

A particularly unique feature of the transport information system described is the ability to coordinate a mix of fare-based and non-fare based transportation. Thus a municipal transportation agency charged with servicing a variety of transportation services, including school transportation services, paratransit services, and traditional route services, may cover these needs comprehensively utilizing a common fleet of vehicles, simply by applying the appropriate fee or incentive to each trip or service. Utilizing the transport information system as described, a driver will have equal incentive to perform a paratransit trip (with no fare, but incentive), a school trip (with no fare, but incentive), or a public multistop route (with fares). As well, a benefit is that drivers may have experience operating a wide range of transportation services, further ensuring flexible, cross-trained drivers operating vehicle fleet 250.

The fees and incentives described in this invention may be paid to and disbursed from a company which owns the vehicles in fleet 250. Inasmuch as net fees charged exceed incentives paid, this net amount may cover operating costs and provide operating income for the company. In cases where much non-fare routes and trips are serviced, the company may negotiate a subsidy from a government agency.

The TargetDriverRevenue value may be regulated by government or oversight agency, and may be determined to ensure a proper living wage for the typical driver.

While the fleet of transportation service vehicles 250 described here are engaged in the transportation of people, it should be recognized that transport information system 200 may also be applied to enable the self-directed coordination of a fleet of vehicles transporting materials, or a combination of people and materials. In the case of materials transport, fares may be replaced by delivery receipts, where a delivery receipt represents a completed delivery of a given material to the requested location. The delivery receipt may have attached specific cash value to the vehicle driver, the cash paid either directly by the recipient of the package or via the transportation company, and therefore has a similar motivational effect to fares generated by servicing passenger routes or trips. Thus, the transport information system as applied to the transportation of materials accomplishes the goal of providing efficient, customer-focused service.

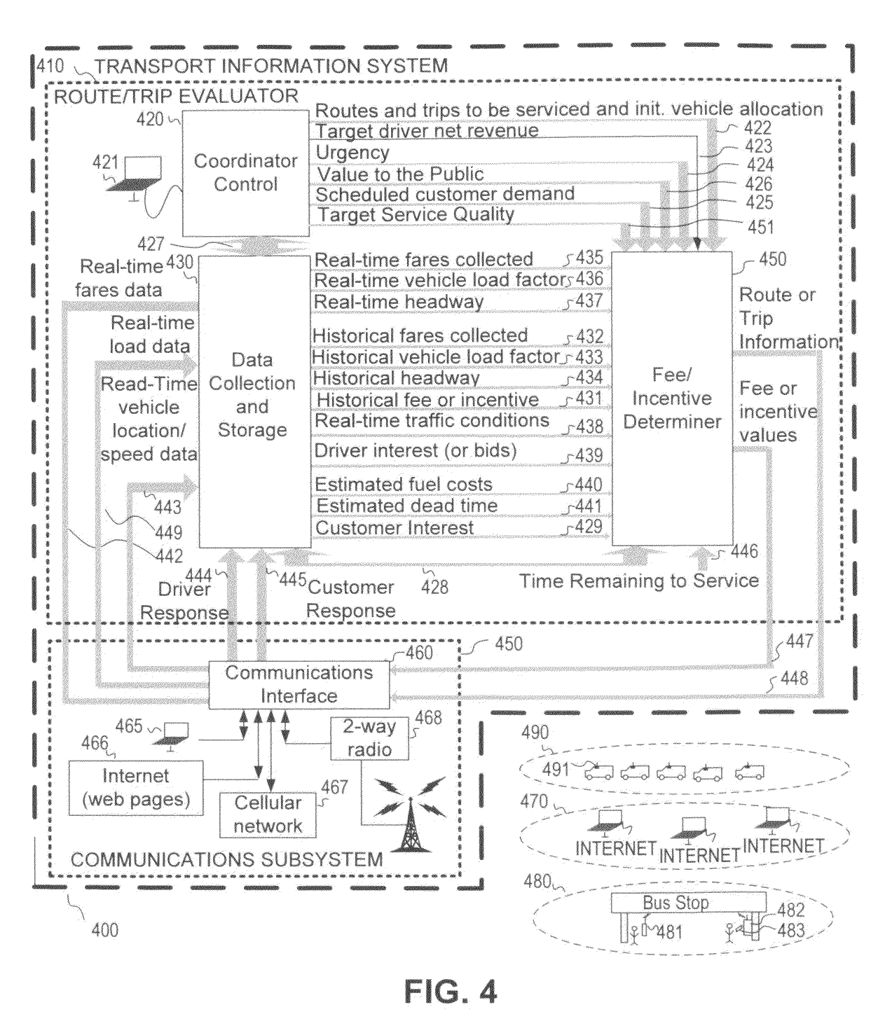

FIG. 4 illustrates several other embodiments of the invention. Like the embodiments shown in FIG. 2, FIG. 4 depicts a transport information system 400. However, a fee/incentive determiner 450 is now shown as part of the larger route/trip evaluator block 410, which also includes coordinator control block 420 and data collection and storage block 430. Coordinator control block 420 and data collection and storage block 430 each provide a multiplicity of inputs to fee/incentive determiner 450, providing a rich variety of factors from which fee/incentive determiner 450 may appropriately and efficiently determine the fees or incentives for various routes and trips. The goals of transport information system 400 may then be expanded to include improved coverage control of the service area, more precise, consistent, fair and efficient economic motivation of the drivers, control of quality of service, flexibility and reaction to real-time circumstances and events, responsiveness to customers, and reliability, among others.

Additionally, communications subsystem 450 may be included to expand communications options over those shown in FIG. 2. Communications interface 460 serves as a gateway, reformatting and passing information between route/trip evaluator 410 and various communication channels, including computer terminal 465, internet (web pages) 466, a cellular network 467, and 2-way radio 468. The communications channels, in turn, communicate with a variety of entities, including the users of internet terminals 470, passengers at a bus stop 480, and vehicles in fleet 490 utilizing wireless-enabled in-vehicle systems.

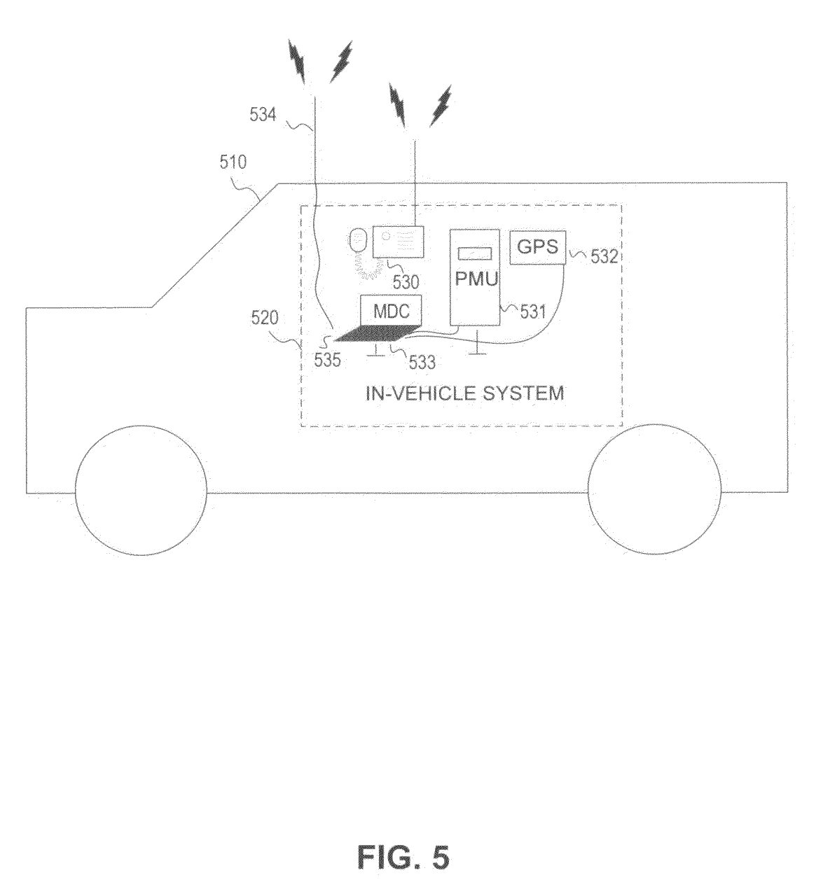

FIG. 5 describes the in-vehicle systems in more detail. Vehicle 510 may be one typical vehicle in a fleet serving routes and trips within the transportation system described. In-vehicle system 520 is a data collection and communications system designed to provide transport information system 400 with useful real-time information for determining fees and incentives for the routes and trips to be serviced. GPS unit 532 may be a commercial mobile global positioning system unit, capable of determining the vehicle location and speed at any given time. GPS unit 532 may be connected to mobile digital computer (MDC) 533 via a USB connection, with MDC 533 operating a software program which polls GPS unit 532 periodically for location and speed fixes. Software in MDC 533 tabulates and stores this data. Passenger monitoring unit (PMU) 531 is designed to count passengers as they embark onto vehicle 510, and may also track disembarking passengers, thus calculating the vehicle load as the difference between passengers embarking and passengers disembarking. Further, PMU 531 may monitor fares received from passengers. In a preferred mode of operation, PMU 531 additionally collects fares, either collecting cash or reading a passenger's electronic fare card (not shown), verifying its validity for the transportation requested, and registering a debit on the passenger's account to account for the service provided. In the case where the passenger's fare card account indicates a monthly pass or no-cost transfer, no debit is registered. Preferentially, PMU 531 may be connected to MDC 533, with MDC 533 operating a software program which communicates between PMU 531 and MDC 533. Radio 530 may be a 2-way radio for voice communications, utilized for communications to the transport information system. Preferentially, MDC 533 is connected to the internet through a mobile WAN (wide-area network) connection, such as is available through a typical 3G HSPA network. For this purpose, MDC 533 may utilize a mobile WAN data modem 535 connected to antenna 534 for enhanced connectivity. Thus, MDC 533 communicates across communications interface 460 to data collection and storage block 430, utilizing the internet communications channel 466.

Utilizing the communications connection just described, MDC 533 further may provide information to the driver of vehicle 510 from transport information system 400. For example, a description of available routes or trips, together with associated fee or incentive values may be provided for display on the screen of MDC 533. Maps of the routes or trips, service type information, distances, dates and times of service, customer contact information if needed, informational notes, instructions to begin and end service based on GPS and time, and other relevant information may be displayed. MDC 533 may also provide the driver with ability to communicate with transport information service 400. The driver may opt to service available routes or trips, and register this interest using MDC 533. The driver may also utilize MDC 533 to provide a bid amount for a route or trip (described later). MDC 533, in turn, may transmit this information via WAN card 535 through the cellular network 467, across communications interface 460 to data collection and storage block 430 via driver response 444.

Returning to FIG. 4, coordinator control block 420 collects basic transportation system inputs, and may be administered by transit administrators communicating these inputs via computer terminal 421. These inputs may include requested trips communicated by customers to the administrator, or any information needed by fee/incentive determiner 450 as will be described. These inputs are then passed on to fee/incentive determiner 450. Coordinator control block 420 and associated terminal 421 may together comprise a computer system running a user interface program to display and prompt for information from computer terminal 421, and the same computer system may store these inputs on memory media such as a hard disk drive. These inputs may be provided to fee/incentive determiner 450 in the form of electronic files transmitted across a computer network from coordinator control block 420.

The inputs provided from coordinator control 420 to fee/incentive determiner 450 will now be described. “Routes and trips to be serviced and initial vehicle allocation” 422 provides information describing the routes or trips to be served as requested by coordinator control 420, and may include GIS, map and service type information, distances, dates and times of service, customer contact information if needed, informational notes, and the number of vehicles required for service if known. “Target driver revenue” 423 provides the target revenue that is determined as appropriate for the drivers, as described previously. “Urgency” 424 provides a number which relates the urgency of servicing for a particular route or trip. For example, urgency 424 may be a percentage number, with 0% indicating average urgency, +10% indicating a higher urgency, and −10% indicating a lower than average urgency, for a given route or trip. The transit administrator at coordinator control 420 may determine this value. In the case of an urgent transportation need, such as a medical paratransit trip, a very high positive number for urgency 424 may be provided, such as 50%. For moderately urgent transportation need, such as motivating drivers to service a route to improve service quality, a moderately high number for urgency 424 may be provided, such as 10%. “Value to the public” 425 provides a number which relates to the public importance of servicing the route or trip. For example, value to the public 425 may be a number from 1 to 10, with 1 being lowest value to the public, and 10 being highest, for a given route or trip. The transit administrator at coordinator control 420 may determine this value. In the case of a transportation need that is deemed important to the public, such as transportation of children from school, a high number for value to the public 425 may be provided, while a low number may be provided for a a route service which is considered less important. “Scheduled customer demand” 426 provides an estimate of anticipated demand, predicted for future days and times, associated with routes and trips. For example, scheduled customer demand 426 may be a positive or negative percentage number, with an associated time period, representing the percentage demand above or below a determined average, respectively, for a given route or trip. In the case of lower than average demand, such as might be expected during a holiday, a negative percentage number may be provided along with the holiday date. “Target service quality” 451 provides targets for headway, loading capacity, speed of service, and any other variables related to the quality of service for the customer.

Data collection and storage block 430, on the other hand, collects, formats, and stores both real-time and historical information regarding the operations and servicing of the routes and trips handled by transport information system 400, and provides this information to fee/incentive determiner block 450 (and in some cases to coordinator control 420 through interface 427).

Data collection and storage block 430 receives raw incoming data reported from the vehicles from time to time, arriving from real-time fares data 442, real-time load data 449, and real-time vehicle location/speed data 443. This raw data is collected across communications interface 460, where it is received via one of several communications channels (typically internet 466 or cellular network 467) from the vehicles in fleet 490. Driver response 444 and customer response 445(both described in detail later) provide further raw data, related to inputs from the drivers and customers, and is similarly sent across communications interface 460, where it is received via one of several communications channels.

Data collection and storage block 430 may comprise a computer system running a data collection program to collect real-time operational information, interfacing to communications interface block 460 from where it may receive its raw real-time data. Interfaces 427 and 428 may also be provided to collect data from coordinator control 420 and fee/incentive determiner 450, respectively. Besides collecting this data, data collection and storage block 430 may also format and store the collected raw data for real-time and future use, storing the data on memory media such as a hard disk drive. Finally, data collection and storage block 430 may format the raw data and provide useful inputs to fee/incentive determiner 450, typically in the form of electronic files transmitted across a computer network from data collection and storage block 430.

The inputs provided from data collection and storage block 430 to fee/incentive determiner 450 will now be described. “Real-time fares collected” 435 provides the fares collected by the vehicles associated with a given routes or trips. The fares may be actual cash, or vouchers, or electronically recorded credit from a transit debit card, for example, and in the case of a serviced route, may represent the total fares collected during one direction of travel. Real-time fares collected 435 is generated by data collection and storage block 430 from raw incoming data reported from the vehicles from time to time arriving from real-time fares data 442. “Real-time vehicle load factor” 436 provides vehicle load factors experienced by vehicles at various points along given routes being serviced. Vehicle load factor refers to utilization of the total available capacity of a given vehicle, and is expressed as a percentage. Real-time vehicle load factor 436 is generated by data collection and storage block 430 from raw incoming data reported from the vehicles from time to time arriving from real-time load data 449 and real-time vehicle location/speed data 443 (for vehicle location information). “Real-time headway” 437 provides the time between vehicles at various points along given routes being serviced, and may be expressed in minutes. Real-time headway 437 is generated by data collection and storage block 430 from raw incoming data reported from the vehicles from time to time arriving from real-time vehicle location/speed data 443, and can be calculated by knowing the average speed of a vehicle at a given point along a given route, and its distance from the vehicle ahead of it. “Historical fares collected” 432, “historical vehicle load factor” 433, and “historical headway” 434 provide a past record of archived real-time fares collected, real-time vehicle load factors, and real-time headways. “Historical fee or incentive” 431 provides a past record of the fees or incentives associated with the routes and trips collected from fee/incentive determiner 450 via interface 428. “Real-time traffic conditions” 438 provides information regarding traffic conditions relevant to the routes and trips, which may be based on data from real-time vehicle location/speed data 443 or based on data from third-party traffic information providers. In both cases, data is collected across communications interface 460. “Driver interest (or bids)” 439 provides information regarding the vehicle drivers' acceptance of various route and trip offers with associated fees or incentives from fee/incentive determiner 450, and may include historically archived information. In some cases, the “driver interest (or bids)” 439 provides information regarding the vehicle drivers' bids, representing a willingness to service a particular route or trip for a specific fee or incentive proposed by the drivers.' “Historical driver interest” 461 provides a past record of the driver interest (or bids) associated with the routes and trips collected from fee/incentive determiner 450 via interface 428. “Estimated fuel costs” 440 and “estimated dead time” 441 provide estimates of fuel costs of servicing the routes or trips, and the approximate time driving to/from the routes and trips, and may be specific to individual vehicles.

“Customer interest” 429 provides information regarding a real-time assessment of the degree of customer interest existing for various routes and trips, which may be based on data from “customer response” 445 information collected across communications interface 460. Customer interest may be further understood by the actions of passengers at bus stop 480, located on a given route. One passenger may use cellphone 481, for example, to communicate an interest in obtaining transportation from the bus stop. The passenger may communicate this interest by sending an SMS text message with cellphone 481 to communications interface 460, via cellular network 467. The location of the passenger is known either by the content of the SMS message, or by location information transmitted by the cellphone. Another passenger may utilize transit card reader 483 to communicate an interest in obtaining transportation, by providing a transit card 482 to be read by transit card reader 483, thus registering his or her interest at the bus stop. The transit card may be the same electronic debit card utilized by a passenger to pay fares, and provide an interface to be read in a contactless fashion. Transit card reader 483 may be designed to read transit card 482, recognizing a potential passenger, and may be equipped with a cellular-enabled data communications radio, thus communicating this interest to communications interface 460. In all cases, communications interface 460 forwards this information as “customer response” 445, which typically includes time and location information, to data collection and storage block 430. Data collection and storage block 430 may eliminate multiple communications if originating from the same customer.

Returning to FIG. 4, transport information system 400 utilizes fee/incentive determiner 450 utilizing the multiplicity of inputs just described to determine a specific fee (to be paid by the driver) or incentive (an amount paid to the driver), appropriate to each route or trip, providing this information via “fee or incentive values” 447 across communications interface 460, through one of several communications channels, and ultimately to drivers of the vehicles in fleet 490, so they may utilize this information to choose to serve the routes and trips. A description of the trips or routes, which may include GIS, map and service type information, distances, dates and times of service, customer contact information if needed, informational notes, and the number of vehicles required for service along with other information relevant to the trip or route may also be provided by “trip or route information” 448, may also be communicated to the drivers.

Fee/incentive determiner 450 typically comprises a computer running a software program designed to execute an algorithm to determine the fee or incentive values 447 from some combination of inputs as shown in FIG. 4.

In one embodiment, the transport information system 400 may have a primary goal of providing consistent and fair revenue to the vehicle drivers, in addition to route and trip coverage. In a manner previously described in an embodiment illustrated by FIG. 2, fee/incentive determiner 450 may subtract an estimate of fare revenue (if any) from a constant-valued target driver revenue to determine the fee or incentive for a given route or trip. Thus, the financial incentive for the drivers to service any of the routes or trips is theoretically equalized, motivating a balanced interest from the drivers to serve all trips and routes, ensuring comprehensive service coverage. Referring to FIG. 4, an estimate of fare revenue may be calculated by combining historical fares collected 432 for a representative period of time (for example, one hour), in the past, for the same route or trip. For the constant-valued target driver revenue, target driver net revenue 423 should be scaled to represent the revenue targeted during the same representative period of time (in this example, one hour).

Of course, the period in which historical fares collected 432 is based should match closely the present circumstances such as customer demand and number of vehicles deployed. If an increase or decrease in demand is expected relative to the demand during the period of time from which historical fares collected 432 is taken, the present embodiment provides another mechanism for fee/incentive determiner to adjust the fee or incentive calculation. Scheduled customer demand 426 may be used to increase or decrease, in percentage, the combined historical fares collected 432 value. Thus, a more accurate fee or incentive value 447 for the route or trip may be calculated, using the combined historical fares collected 432 value adjusted by the scheduled customer demand 426 value. Further, estimated fuel costs 440 for the route or trip may be subtracted from the historical fares collected 432 value, to account for the cost of fuel. Thus, a fee or incentive value may be calculated, accounting for variations in fuel costs between various routes and trips. By including scheduled customer demand 426 and estimated fuel costs 440 in the calculation of the fee or incentive for a given trip or route, transport information system 400 further accomplishes the goal of targeting a consistent and fair revenue for the drivers, across all routes or trips under all circumstances.

Also as mentioned previously, the fees and incentives may be paid to and disbursed from a company which owns the fleet of vehicles engaged in the transportation service, and, inasmuch as net fees charged exceed incentives paid, may use this net amount to cover operating costs and provide operating income. In the case where this net amount is insufficient to provide operating income for the company, the company may be provided a government subsidy. The target driver net revenue value for may be regulated by government or oversight agency, and may be determined to ensure a proper living wage for the typical driver.

In another embodiment, another goal of transport information system 400 may be to maintain quality of the service, typically with regards to headway (time between vehicles), loading capacity (ensuring adequate vehicle capacity to serve passengers loads), and speed of service. This goal may be in addition to the goals already described. For example, an unexpected increase in passenger ridership on a given route may be detected by fee/incentive determiner 450 if real-time vehicle load factor 436 reaches a level some margin greater than historical vehicle load factor 433. Or, real-time vehicle load factor 436 may reach a level greater than the limit provided by target service quality 451. Target service quality 451 may provide a target value indicating the maximum percentage of vehicles that carry passengers at peak seating capacity, and real-time load factor 436 may indicate a value exceeding this target value for a given route, indicating an unacceptable number of vehicles are full and unable to service waiting passengers in the route. A high load factor may also decrease speed of service. Thus, this given route is considered underserved. In another example, real-time headway 437 may be monitored by fee/incentive determiner 450. A higher than expected value for real-time headway would indicate longer than expected wait times for passengers. If real-time headway 437 reaches a level some margin greater than historical headway 434, the route may be considered underserved. Or, real-time headway 437 may reach a level greater than the limit provided by target service quality 451. Target service quality 451 may provide a target value indicating a maximum wait-time between vehicles, again determining this route as underserved.

To correct the situation of an underserved route, fee/incentive determiner 450 may take action by first providing an option for an appropriate number of additional vehicles to service this underserved route, sufficient to acceptably improve service quality, by updating route or trip information 448 to indicate this option to those drivers currently servicing other routes or trips. Typically, the option is provided to only those drivers currently servicing routes or trips with sufficient capacity whereby the removal of their vehicle from servicing would not cause unacceptable quality of service impact. For example, fee/incentive determiner 450 may estimate the loading and headway impact of removing vehicles on other routes in service to determine to which drivers to extend the option of servicing the underserved route. Further, fee/incentive determiner 450 may determine a fee or incentive value 447 set to be more attractive than other routes or trips, in order to expeditiously motivate drivers to service the route. For example, fee/incentive determiner 450 may lower the fee or incentive value 447 for the underserved route by 10%, compared with the current fee or incentive value. For the sake of fairness, other drivers already servicing the underserved route may also be charged this lower fee or incentive.

As an alternative to the above automated process, coordinator control block 420 may have access to the monitoring of these conditions via interface 427. Data from real-time vehicle load factor 436, real-time headway 437, historical vehicle load factor 433, and historical headway 434 may be available across interface 427 and displayed on computer terminal 421. A transit administrator may view this data to determine the appropriate action, which may include adding vehicles to service the underserved route. If action is deemed necessary, the transit administrator may update routes and trips to be serviced and initial vehicle allocation 422 to indicate the option of servicing the underserved route as described previously, and also provide an urgency 424 value indicating a relatively high urgency for the route to be further serviced. The transit administrator may set an urgency level of 10%. Fee/incentive determiner 450 may therefore increase the prior determined fee or incentive value 447 for the underserved route by 10%. Additionally, fee/incentive determiner passes on updated route or trip information 448 based on routes and trips to be serviced and initial vehicle allocation 422 from coordinator control 420.

Fee/incentive determiner may then communicate route or trip information 448 and fee or incentive information 447 to the drivers of fleet 490 in real time, across communications interface 460, through one of the communications channels previously described in communications subsystem 450. Thus, the drivers of vehicles in fleet 490 may view these new opportunities to serve the underserved route, and service the route, motivated by the fee or incentive provided by fee/incentive determiner 450 and any fare revenue the driver may estimate from servicing the route. Thus, the quality of service of the routes and trips is maintained utilizing transport information system 400.

Thus, by monitoring real-time quality indicators such as real-time load factor 436 and real-time headway 437 for each route, and taking the actions as described, transport information system 400 achieves the goal of maintain the quality of the transportation service.

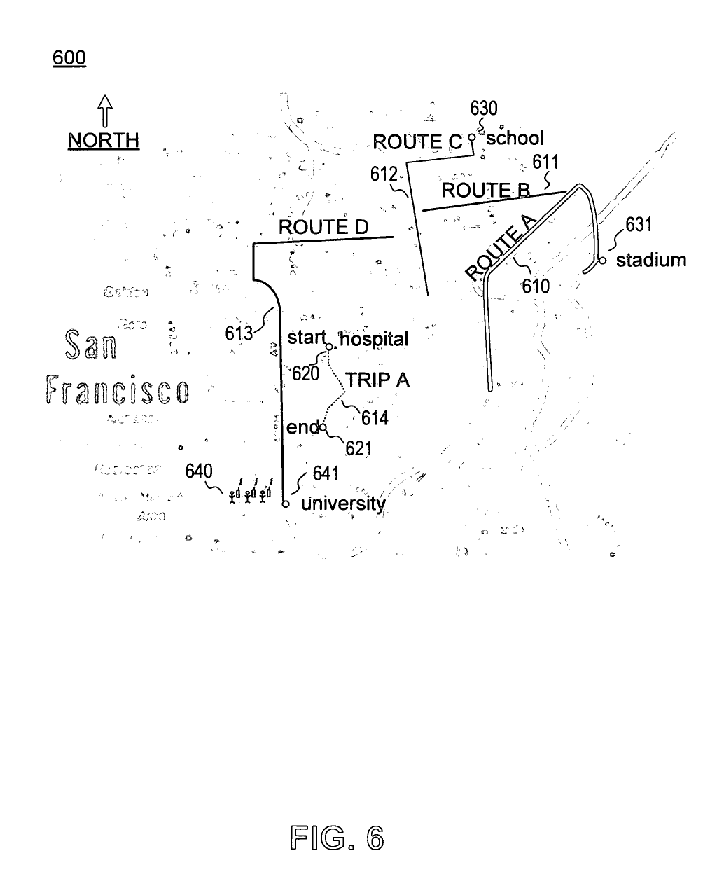

In another embodiment, flexibility and responsiveness to customers may be a key goal of the transport information system 400. Turning to FIG. 6, map 600 will be used to help illustrate the embodiment described. Map 600 is similar to map 300 from FIG. 3, but adds ROUTE C (612) with school 630, and ROUTE D (613), with university 641 and passengers at the university 640 As well, stadium 631 is added along ROUTE A (610). Passenger volume is generally low on ROUTE D(613).

On ROUTE D, students of university 641 are potentially passengers of the route, which serves a residential area to the north of university 641. Since passenger volume is relatively low on ROUTE D, coordinator control 420 will likely have assigned a low initial vehicle allocation to serve ROUTE D. Turning back to FIG. 4, passengers 640 at the university641 however may register their interest in service along ROUTE D by communicating using their cellular phones to register “customer response” 445 information to data collection and storage block 430, collected across communications interface 460. This scheme of registering customer response 445, along with other schemes for registering customer interest, has been previously described. Data collection and storage block 430 then provides customer interest 429 information to fee/incentive determiner 450.

To ensure service to passengers 640, fee/incentive determiner 450 may take action similar to the action taken to serve quality goals described previously. Fee/incentive determiner 450 first provides an option for an appropriate number of additional vehicles to service this underserved route, by updating route or trip information 448 to indicate this option to those drivers currently servicing other routes or trips. The appropriate number of vehicles may be determined, in part, by the number of passengers registering their interest along ROUTE D. Typically, the option to serve the route is provided to only those drivers currently servicing routes or trips with sufficient capacity whereby the removal of their vehicle from servicing would not cause unacceptable service impact. Further, fee/incentive determiner 450 may determine a fee or incentive value 447 set to be more attractive than other routes or trips, in order to expeditiously motivate drivers to service the route. For example, fee/incentive determiner 450 may lower the fee or incentive value 447 for the underserved route by 10%, compared with the current fee or incentive value. For the sake of fairness, other drivers already servicing the underserved route may also be charged this lower fee or incentive.

As an alternative to the above automated process, data collection and storage block 430 may instead communicate the customer response 445 to coordinator control 420 via interface 427, where a transit administrator may update routes and trips to be serviced and initial vehicle allocation 422 to indicate the option of servicing the underserved route as described previously, and also provide an urgency 424 value indicating an urgency for the route to be further serviced. The transit administrator may set an urgency level of 20%. Fee/incentive determiner 450 may therefore increase the prior determined fee or incentive value 447 for the underserved route by 20%. Additionally, fee/incentive determiner passes on updated route or trip information 448 based on routes and trips to be serviced and initial vehicle allocation 422 from coordinator control 420.

Fee/incentive determiner may then communicate route or trip information 448 and fee or incentive information 447 to the drivers of fleet 490 across communications interface 460, through one of the communications channels previously described in communications subsystem 450. Thus, the drivers of vehicles in fleet 490 may view these new opportunities to serve the underserved route, and service the route, motivated by the fee or incentive provided by fee/incentive determiner 450 and any fare revenue the driver may estimate from servicing the route. Thus, the goal of providing flexibility in the transport system is provided by transport information system 400.

In another example where flexibility as well as reliability may be a key goal of the transport information system 400, school transportation needs may be served utilizing the present invention. Turning again to FIG. 6, ROUTE C (612) is a light-density route with generally few passengers, serving generally residential areas. However, the ROUTE C (612) serves very high passenger volumes just prior to and just after school hours, when the route serves students attending school 630 at the northern terminus of the route.

Returning to FIG. 4, transit administrators may set up two special one-direction school routes along ROUTE C to exclusively serve students attending school 630. One of the routes takes place in the morning, delivering the students to the school, while the other route transports the students back from school. The timing of the routes may change from day to day to accommodate school schedules, holidays, special school events, etc. The route information may be entered via computer terminal 421, along with an initial vehicle allocation appropriate to serve the volume of students; this data is then provided to fare/inventive determiner 450 via routes and trips to be serviced and initial vehicle allocation 422. No fare revenue is expected, and thus fee/incentive determiner 450 initially determines an incentive values equal to target driver net revenue 423, scaled according to the estimated time to serve the routes. However, to ensure the most reliable service for these school routes, the transit administrator may set a relatively high value to the Public 425 value. A high value to the Public 425 value may cause fee/incentive determiner 450 to filter route or trip information 448 to allow these routes to be served only by highly qualified drivers. For example, only those drivers with at least 5 years experience and specialized training may be offered these school routes. Thus, transport information system 400 enables a flexible, reliable school transportation system.

In yet another example where flexibility may be a key goal of the transport information system 400, unusually high level loads associated with special events may be accommodated by utilizing the present invention. Turning again to FIG. 6, ROUTE A (610) includes stadium 631 near its eastern terminus. Before and after events at stadium 631, a very high load of passengers may be experienced by the vehicles serving ROUTE A.

Returning to FIG. 4, transit administrators may set up a special route along ROUTE A to overlay existing ROUTE A, entered via computer terminal 421, along with an initial vehicle allocation appropriate to serve the volume of stadium attendees; this data is then provided to fare/inventive determiner 450 via routes and trips to be serviced and initial vehicle allocation 422. Fee/incentive determiner 450 then first provides an option for drivers to service this route, by updating route or trip information 448 to indicate this option to those drivers currently servicing other routes or trips. Typically, the option is provided to only those drivers currently servicing routes or trips with sufficient capacity whereby the removal of their vehicle from servicing would not cause unacceptable service impact. Thus, transport information system 400 provides a flexible system to accommodate high level loads.

In cases of emergency or natural disaster, transit administrators may invoke a special “command mode.” In this case, all vehicles in fleet 490 serving any routes or trips must follow directions directly from coordinator control. Individual vehicles may be directly assigned routes or trips by coordinator control 420, communicated through fee/incentive determiner 450. Fee/incentive determiner may then communicate route or trip information 448 and fee or incentive information 447 to the drivers of fleet 490 in real time, across communications interface 460, through one of the communications channels previously described in communications subsystem 450. Thus, the drivers of vehicles in fleet 490 may respond to the directly assigned routes and trips, and the transport information system 400 enables a flexible transportation system in the case of emergency.

In another embodiment, driver interest is monitored by fee/incentive determiner 450, as a further refinement to transport information system 400 to achieve the primary goals of providing efficient economic motivation, and coverage. Data collection and storage block 430 provides driver interest (or bids) 439 information to fee/incentive determiner 450. Driver interest (or bids) 439 information comprises a combination of historical and real-time information, derived from driver response 444 data. Driver response 444 comprises raw real-time responses from the drivers of the vehicles in fleet 490 to offered choices of routes and trips. Driver response 444 data may be logged and processed by data collection and storage block 430, to provide a timeline of interest in a given route or trip ahead of its scheduled service time. For example, such data may show, for a given route or trip, 100% more vehicles still required 2 days before the scheduled service time, and 30% more vehicles still required 1 day before the scheduled service time. This data may be stored as historical data, and later compared with real-time data comprising the same routes or trips. If a high level of real-time interest along the timeline is found compared with historical data for the same route or trip, fee/incentive determiner 450 may increase the fee or incentive values 447 to be provided to the drivers. Conversely, if a low level of real-time interest along the timeline is found compared with historical data for the same route or trip, fee/incentive determiner 450 may decrease the fee or incentive values 447 in order to spur interest in the trip or route. This concept may be extended further to include yield management principles, wherein the fee/incentive determiner 450 adjusts the fee or incentive values 447 according to the driver interest and time remaining to the service start time of the route or trip.

A bidding system may be implemented as well, wherein drivers are open to provide their own bids on a future route or trip. The bids may be in the form of an offer to serve a route or trip for a driver-specified fee or incentive. Fee/incentive determiner 450 then collects these bids and assigns the highest fee (or lowest incentive) bidders the route or trip.

In the described embodiments, fee/incentive determiner 450 determines a fee or incentive for various trips and routes based on various combinations of inputs. It should be clear that these are a few, limited examples of possible configurations of transport information system 400. In fact fee/incentive determiner 450 may benefit from using any combination of inputs described to determine a fee or incentive for each route or trip to be serviced, in order to target any or all of the following goals of the transport information system 400: consistent, fair and efficient economic motivation of the drivers, control of quality of service, flexibility and reaction to real-time circumstances and events, responsiveness to customers, and reliability. Thus, to achieve any combination of these goals, fee/incentive determiner 450 may determine fee or incentive values 447 responsive to any combination of inputs, including routes and trips to be serviced and initial vehicle allocation 422, target driver net revenue 423, urgency 424, value to the Public 425, target service quality 451, scheduled customer demand 426, real-time fares collected 435, real-time vehicle load factor 436, real-time headway 437, historical fares collected 432, historical vehicle load factor 433, historical headway 434, historical fee or incentive 431, real-time traffic conditions 438, driver interest (or bids) 439, estimated fuel costs 440, estimated dead time 441, and customer interest 429.

While the description of the transport information system 400 generally describe a specific structure of blocks, a route/trip evaluator comprising coordinator control 420, data collection and storage block 430, and fee/incentive determiner 450; and a communications subsystem including a communications interface 460, it should be recognized that these blocks are just one example of a partitioning of the system. Any alternative partitioning to realize the functionality of transport information system 400 described may be used. In just one example, coordinator control 420, data collection and storage block 430, and fee/incentive determiner 450 may be combined into one entity, comprising a single computer.

In another embodiment, transport information system 400, together with in-vehicle system 520 illustrated in FIG. 5, enables a driver compliance system. In-vehicle system 520 provides useful real-time information for ensuring driver compliance to servicing the driver's chosen route or trip. When a driver in fleet 490 chooses a route or trip to service, the driver may communicate this intention via MDC 533, which transmits this information via WAN card 535 through the cellular network 467, across communications interface 460 to data collection and storage block 430 via driver response 444. Data collection and storage block 430 may thus register the particular vehicle as serving a particular route or trip and communicate this information to coordinator control 420 via interface 427. Data collection and storage block 430 may also communicate real-time vehicle location/speed data 443 to coordinator control 420 via interface 427. Coordinator control 420 may include a software program to determine a match between specific vehicles and their intended route, utilizing this information, and providing an alert to the transit administrator via terminal 421 upon a lack of such match to inform the transit administrator of a compliance issue.

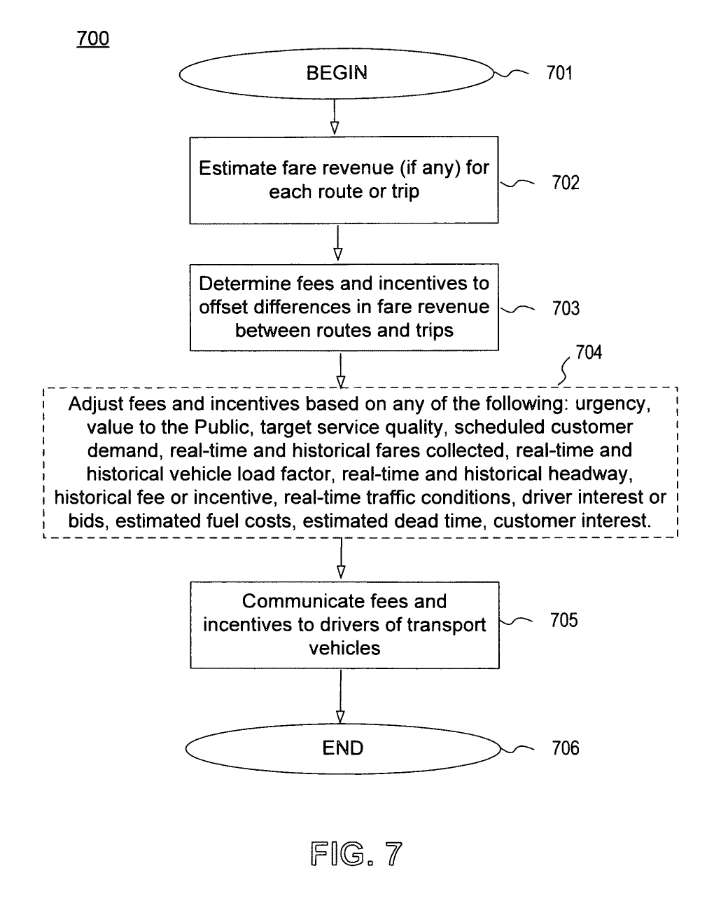

Turning to FIG. 7, flowchart 700 illustrates a method to enable the self-directed coordination of multiple vehicles engaged a transportation service, according to the present invention. As the process begins 701, fare revenue (if any) for each of the routes or trips requiring service is estimated 702. Fare revenue may be estimated using historical records of equivalent or similar routes or trips occurring in the past under similar circumstances. Alternatively, fare revenue may be simply estimated empirically by an experienced transit planner.

Next, fees (to be charged to the driver) and/or incentives (to be paid to the driver) are determined to offset differences in fare revenue between routes and trips 703. That is, a higher fee is determined for routes or trips with higher anticipated fare revenue, while a lower fee is determined for routes or trips with lower anticipated fare revenue. In some cases where very low (or nonexistent) fare revenue is anticipated for routes or trips, an incentive to be paid to the driver is determined.

Next, optional step 704 may be performed. In step 704, the fees and/or incentives determined in step 703 may be adjusted to generate adjusted fees and incentives, based on any of the following factors: urgency, value to the Public, target service quality, scheduled customer demand, real-time and historical fares collected, real-time and historical vehicle load factor, real-time and historical headway, historical fee or incentive, real-time traffic conditions, driver interest or bids, estimated fuel costs, estimated dead time, customer interest. The meaning and source of these factors has been described previously.

Next, the fees and incentives determined in step 703 (and optionally adjusted in step 704) are communicated to the drivers of the transport vehicles 705, and the process ends 706. By communicating the fees and incentives to the drivers of the vehicles, the drivers may consider this information and subsequently choose from among the routes and trips offered and their associated fees or incentives. Since in step 703 the fees and incentives were determined to offset differences in fare revenue between the routes and trips, a relatively uniform financial motivation exists between the route and trips, and thus the drivers of the vehicles are likely to comprehensively service all routes and trips needed. If step 704 has adjusted any of the fees or incentives, a desired enhanced financial motivation may exist to serve some routes or trips above others, resulting in a desired adjustment in the servicing of the routes or trips. Thus, the method illustrated by flowchart 700 enables the self-directed coordination of the vehicles serving the given routes and trips.

What is claimed is:

1. A transport information system for determining and communicating fees or incentives to a fleet of vehicles engaged in transportation service of people or materials, the system comprising:
a fee/incentive determiner for determining a fee or incentive for each route or trip, the fee or incentive computed at least in part on the basis of estimated fare revenue from servicing a given route or trip; and
a communications apparatus to communicate the determined fees or incentives from the fee/incentive determiner to the drivers of the fleet of vehicles.

2. The transport information system of claim 1, wherein the communications apparatus includes a device which further allows the drivers to communicate choices of routes and trips they wish to service.

3. The transport information system of claim 1, wherein fee/incentive determiner determines that at least one route or trip requires a fee and at least one route or trip requires an incentive.

4. A transport information system for self-directed coordination of a fleet of vehicles engaged in transportation service of people or materials, the system comprising:
a route/trip evaluator including a fee/incentive determiner for determining a fee or incentive for each route or trip, the fee or incentive computed at least in part on the basis of estimated fare revenue from servicing a given route or trip; and
a communications subsystem including a bidirectional communication channel for passing the determined fees or incentives from the fee/incentive determiner to the drivers of the fleet of vehicles, and for passing the choices of routes and trips the drivers of the vehicles wish to service to the route/trip evaluator.

5. The transport system of claim 4, wherein the fee/incentive determiner determines a fee or incentive for each route or trip at least in part on the basis of historically recorded fare revenue data collected from prior servicing each route or trip and a target driver net revenue.

6. The transport system of claim 4, wherein the fee/incentive determiner determines a fee or incentive for each route or trip at least in part on the basis of anticipated customer demand.

7. The transport system of claim 4, wherein the communications subsystem further includes a communication channel to register customer interest in the service of a route or trip; and wherein the fee/incentive determiner determines a fee or incentive for each route or trip at least in part on the basis of customer interest.

8. A transport information system for self-directed coordination of a fleet of vehicles engaged in transportation service of people or materials, the system comprising:
in-vehicle systems installed in each vehicle, for communicating the determined fees or incentives from the fee/incentive determiner to the drivers of the fleet of vehicles, for allowing the drivers of the fleet of vehicles to communicate choices of routes and trips they wish to service to the route/trip evaluator, and additionally for collecting real-time data and communicating this data to the route/trip evaluator, the in-vehicle system including a GPS unit;
a route/trip evaluator including a fee/incentive determiner for determining a fee or incentive for each route or trip, the fee or incentive computed at least in part on the basis of estimated fare revenue from servicing a given route or trip and information from the GPS; and
a communications subsystem including a bidirectional communication channel for passing information between the in-vehicle systems and the route/trip evaluator.

9. The transport system of claim 8, wherein:
the in-vehicle systems monitor fare collection during the servicing of the routes or trips, and communicate the monitored fare collection data to the route/trip evaluator; and
the route/trip evaluator includes a fee/incentive determiner for determining a fee or incentive for each route or trip, the fee or incentive computed at least in part on the basis of fare collection data.

10. The transport system of claim 8, wherein:
the in-vehicle systems monitor passenger load during the servicing of the routes or trips, and communicate the monitored load data to the route/trip evaluator; and
the route/trip evaluator includes a fee/incentive determiner for determining a fee or incentive for each route or trip, the fee or incentive computed at least in part on the basis of load collection data.
